(19) United States
(12) Patent Application Publication
(10) Pub. No.: US 2004/0144559 A1
(43) Pub. Date: Jul. 29, 2004

(54) Flexible braided electrical cable bundle

(76) Inventors: Matthew Menze, Marquette, MI (US); Peter C. Menze, Marquette, MI (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/351,838

(22) Filed: Jan. 27, 2003

(51) Int. Cl. H01B 1/00

(52) U.S. Cl. 174/103; 174/72 R

(57) ABSTRACT

A flexible braided wiring harness including a protective sleeve that separates a braided layer from a wire bundle such that the braided layer does not apply a compressive force to the wire bundle. Though the braided layer is tightly braided around the protective sleeve, the lack of compressive force on the wire bundle allows the individual wires of the wire bundle to slide relative to each other when the wiring harness bends. The freedom of the individual wires to slide relative to each other gives the wiring harness improved flexibility.

### BACKGROUND OF THE INVENTION

The present invention relates generally to a method of making a braided electrical cable bundle having increased flexibility and more particularly to a wiring harness including a braided wiring cover formed using the aforementioned method.

Braiding is a method of containing and covering electrical wires or cables to protect them from weather and abrasion. Typical, several straight wires are surrounded by a covering of braided fibers. These fibers may be any of a variety of materials. Examples include stainless steel, fiberglass, nylon, KEVLAR® aluminum, and the like. Braiding is accomplished by placing a bundle of wires to be covered in a braiding machine. The braiding machine, using fibers loaded into the machine, braids the fibers tightly around the bundle of wires. The resulting braided wire bundle is somewhat protected and held together by the braiding. Tighter braiding results in greater protection. Tight braiding, however, creates a wire bundle that is significantly stiffer than the combined stiffness of the individual wires. The stiffness is caused by friction between the individual wires. As a bundle of wires bends, the resulting curvature of the bend requires a shifting of the wires that are located towards the outside of the bend, relative to the wires located towards the inside of the bend. The binding force of the braiding creates a higher level of friction, thus limiting the ability of wires to shift. Tighter braiding results in more friction and a stiffer wire bundle.

A stiff wire bundle can be problematic. For example, if each end of a stiff wire bundle is attached to a different component, and the components at either end move relative to each other, the stiffness of the wire bundle concentrates movement to the connection points. Excessive, concentrated movement at the connection points results in work hardening, and eventual brittle failure, of the wire ends.

Often, braiding machines provide an adjustment that allows an operator to decrease the tightness of the braid, thereby providing additional flexibility. Loose braiding, however, is also problematic. In addition to being unsightly, as the wires contained within the braiding are often readily visible, a loosely braided bundle is susceptible to unraveling, snagging, and individual wires protruding through the braiding. Also, due to its significant gaps, loose braiding provides little or no protection for the wires it contains.

There is a need for a wiring harness that protects a cable bundle while providing flexibility, thereby relieving a connection of undo stress.

### BRIEF SUMMARY OF THE INVENTION

The present invention provides a process for bundling cables to form a wiring harness that overcomes the aforementioned problems with the prior art. The process includes placing a protective sleeve over a bundle of cables prior to placing the bundle in a braiding machine. The protective sleeve is selected to suit the intended use of the wiring harness. Examples of preferably protective sleeves include: convoluted split loom tubing, solid convoluted tubing, non-collapsible flexible tubing, and the like. The protective sleeve is preferably non-collapsible to the extent that it provides some structure and prevents the braiding from collapsing onto the wire bundle.

The process begins by selecting and arranging the individual cables of a wire bundle in an appropriate manner. In one embodiment, the wires are sized and arranged for the intended purpose of a harness; the arrangement including any necessary cable branches to allow for three or more connections in one harness. Once the cables are properly arranged and cut to a desired length, they are covered with the protective tubing sleeve. The tubing is selected to have an inner diameter that is slightly larger than the wire bundle, giving the individual wires freedom to slide against each other with relatively little friction when the bundle is bent. Split tubing facilitates ease of installation and branching.

The harness is then placed into the braiding machine and the braid is applied onto the top of the protective tubing. The tubing allows for a uniform braid the entire length of the harness and prevents wires from being able to protrude through the braided covering. The braiding can be applied at the correct tension to produce a uniform and cosmetically correct braid.

### BRIEF DESCRIPTION OF THE DRAWINGS

FIG. 1 is a perspective view of a current conventional braid using no braid support;

FIG. 2 is a perspective view of a conventional braid applied loosely to allow increased flexibility;

FIG. 3 is a perspective view of a harness of the present invention;

FIG. 4 is a perspective view of a protective sleeve of the present invention, showing the cross-sectional area of a lumen defined therein; and,

FIG. 5 is a perspective view of a wire bundle, showing the perimeter formed thereby and the cross-sectional area within the perimeter.

### DETAILED DESCRIPTION OF THE INVENTION

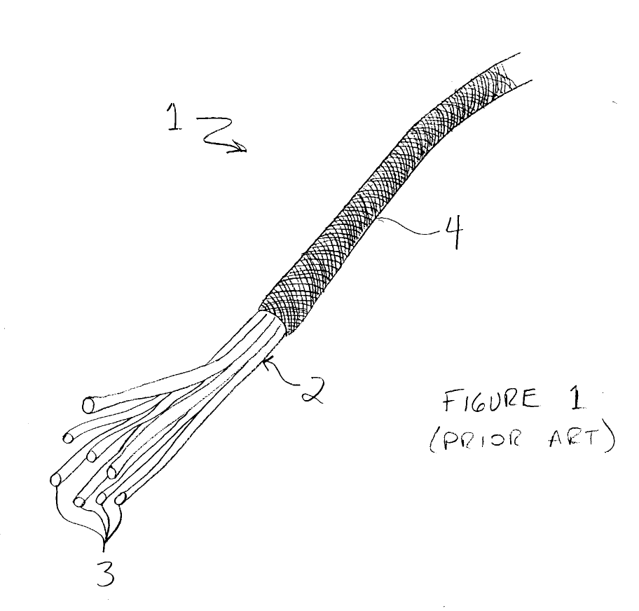

Turning to FIG. 1, there is shown a prior art wire bundle 1 made up of a bundle 2 of individual wires or cables 3. The bundle 2 is held together by a braided layer 4. The braided layer 4 is tightly woven to protect and closely contain the individual cables 3. As a result, the harness 1 is relatively stiff.

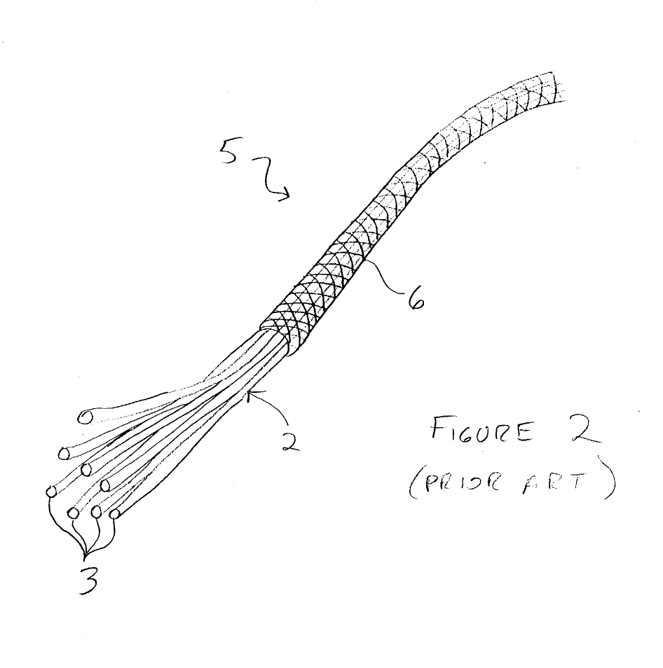

As shown in FIG. 2, a conventional solution to the stiffness problem of the harness 1, such as is shown in FIG. 1, is to provide a harness 5, that is similarly made up of a bundle 2 of individual wires or cables 3, but having a braided layer 6 that is more loosely woven. The loosely woven braided layer 6 creates less friction between the cables 3 than braided layer 4 does, allowing greater flexibility of the harness 5. However, the braided layer 6 also leaves the cables 3 largely exposed. Also, the cable bundle is very loose and unorganized in appearance.

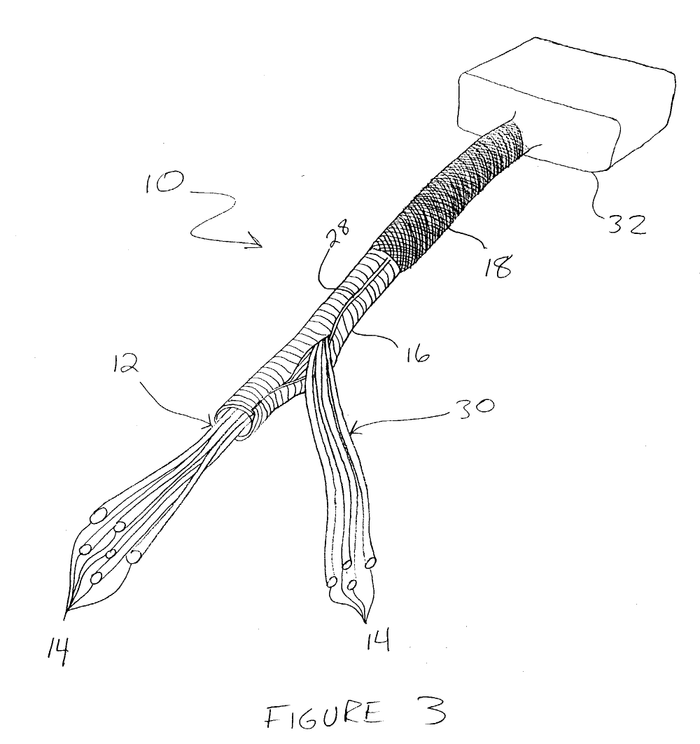

Referring now to FIG. 3, the wiring harness 10 of the present invention includes a bundle 12 of individual wires or cables 14. The bundle 12 is covered by a protective sleeve 16. The protective sleeve 16 is covered with a braided layer 18.

Preferably, the protective sleeve 16 is longitudinally flexible and radially rigid, thus creating a flexible wiring harness 10 that is substantially non-collapsible. The radially rigid property of the protective sleeve 16 allows the braided layer 18 to be tightly braided without sacrificing flexibility.

The protective sleeve 16 is preferably convoluted split loom tubing. Convoluted split loom tubing, as seen in FIG. 3, includes a longitudinal split 28. The split 28 allows the cables 14 to be arranged in a desired configuration, including any necessary branches 30, before the cables 14 are covered with the protective sleeve 16. However, if additional protection is important for a particular application, materials such as solid convoluted tubing, or other types of non-collapsible flexible tubing, may be used as protective sleeve 16.

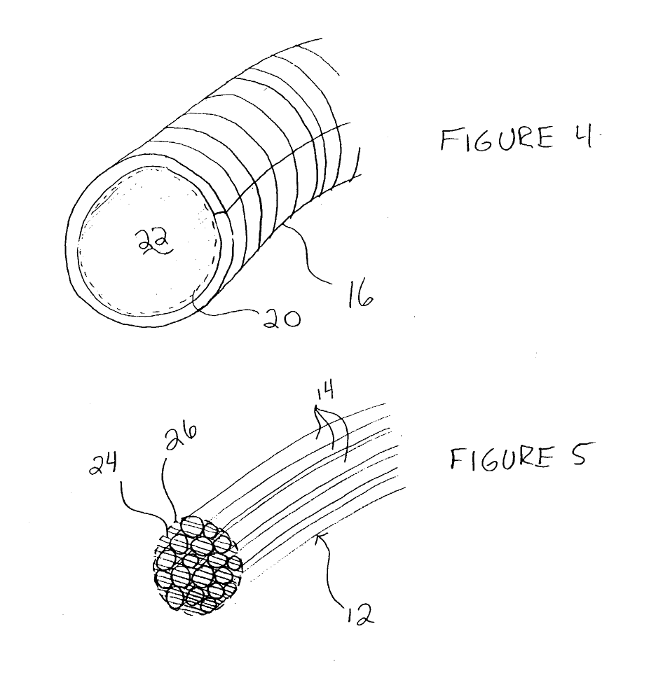

Referring to FIGS. 4 and 5, flexibility of the wiring harness 10 is further enhanced by sizing the protective sleeve 16 such that an inner lumen 20 defined by the sleeve 16, has a cross-sectional area 22 that is bigger than a cross-sectional area 24 of an outer perimeter 26 of the wire bundle 12. Ensuring that cross-sectional area 22 is bigger than cross-sectional area 24 provides a desired amount of play between the individual cables 14, allowing the cables 14 to slide relative to each other when the harness 10 bends.

Thus, constructing a desired wiring harness 10 of the present invention is accomplished in the following manner. The individual cables 14 are selected and sized to accomplish the specific purpose of resulting harness 10. The cables 14 are arranged in a bundle 12, with any necessary branches 30 stemming from the bundle 12. It is important to note that the individual cables 14 may be of a variety of sizes.

Next, a predetermined length of protective sleeve 16 is placed over the arranged bundle 12. If the protective sleeve 16 includes a split 28, the protective sleeve 16 is placed over the bundle 12 such that any branches 30 are protruding from the protective sleeve 16, through the split 28, as seen in FIG. 3. If the branches 30 are of significant length, a second protective sleeve may be placed over the branch 30 in a similar manner.

If a protective sleeve 16 that does not include a split 28 is desired, sections of tubing are cut to lengths that match the various straight sections of cable bundle that exist between branch locations. The tubing sections are then slid over the bundle sections. It may be desirable to fasten the tubing sections to the bundle sections using electrical tape or a similar suitable fastener to hold the tubing sections in place until the braiding is applied.

If the harness 10 is to include connectors 32 (FIG. 3), the connectors 32 are attached to the ends of the bundle 12 and any branches 30 extending therefrom. The connectors 32 may be attached to the bundle 12 and branches 30 before or after the protective sleeve 16 is applied.

The unbraided harness is then placed in a braiding machine (not shown) so that a braided layer 18 may be placed over the protective sleeve 16 and any unprotected branches 30 that may be present. The braiding machine is preferably adjusted to form a relatively tight weave around the protective sleeve 16, as the protective sleeve 16 prevents harness stiffness from becoming an issue. The braid is not so tight, however, as to place a compressive force on the protective sleeve 16 that is sufficient to collapse the structure of protective layer 16, and thus interfere with any desired shifting of the wire bundle 12.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A flexible electrical wiring bundle comprising:
a plurality of wires defining a perimeter and a first cross-sectional area within the perimeter;
a protective sleeve, surrounding said plurality of wires, and defining an inner lumen, said inner lumen having a second cross-sectional area that is greater than said first cross-sectional area, thereby allowing individual wires of said plurality of wires to slide against each other when said harness bends;
a braided layer surrounding said protective sleeve, said braided layer exerting a compressive force around said protective sleeve, said protective sleeve preventing said wire bundle from being subjected to said compressive force.

2. The flexible wiring bundle of claim 1 wherein said protective sleeve comprises flexible vinyl tubing.

3. The flexible wiring bundle of claim 1 wherein said protective sleeve comprises convoluted tubing.

4. The flexible wiring bundle of claim 1 wherein said protective sleeve comprises convoluted split loom tubing.

5. The flexible wiring bundle of claim 1 wherein said wire bundle comprises a plurality of individual wires having various thicknesses.

6. The flexible wiring bundle of claim 1 further comprising at least one branch extending from said wire bundle, said branch including a plurality of wires from said wire bundle.

7. The flexible wiring bundle of claim 6 wherein said branch comprises a second protective sleeve surrounding said plurality of wires.

8. The flexible wiring bundle of claim 7 wherein said branch further comprises a braided layer surrounding said second protective sleeve.

9. The flexible wiring bundle of claim 6 wherein said branch comprises a braided layer surrounding, and in contact with, said plurality of wires.

10. A method of making a flexible wiring harness comprising:
arranging a plurality of individual wires in a bundle, said bundle defining a perimeter, said perimeter defining a first-cross sectional area;
selecting a protective tubing defining an inner lumen having a second cross-sectional area greater than said first cross-sectional area;
placing said protective tubing around said bundle;
braiding a braided layer around said protective tubing.

11. The method of claim 10 wherein arranging a plurality of individual wires in a bundle comprises forming branches with said individual wires that extend away from said bundle.

12. The method of claim 11 further comprising placing protective tubing around said branches.

13. The method of claim 11 further comprising braiding a braided layer around said branches.

14. The method of claim 12 further comprising braiding a braided layer around said protective tubing of said branches.

15. The method of claim 10 wherein braiding a braided layer around said protective tubing comprises braiding a braided layer around said protective tubing that applies a compressive force to said protective tubing but does not cause said protective tubing to apply a compressive force to said bundle.

16. A flexible wiring harness comprising:
a wire bundle of a plurality of individual wires;
a braided layer surrounding said wire bundle;
a means for maintaining a separation between said braided layer and said wire bundle such that said braided layer does not apply a compressive force to said wire bundle; and,
a connector attached to an end of said wire bundle.

17. The flexible wiring harness of claim 16 wherein said means for maintaining a separation between said braided layer and said wire bundle comprises a protective sleeve having an inner lumen defining a cross-sectional area that is greater than a cross-sectional area within a perimeter defined by said wire bundle, the protective sleeve disposed between said braided layer and said wire bundle such that said wire bundle passes through said lumen and said braided layer surrounds said protective sleeve.

18. The flexible wiring harness of claim 16 further comprising at least one branch of at least one wire extending from said wire bundle.

19. The flexible wiring harness of claim 18 wherein said braided layer surrounds one or more of said at least one branch.

20. The flexible wiring harness of claim 19 further comprising a means for maintaining a separation between said braided layer and said one or more of said at least one branch such that said braided layer does not apply a compressive force to said one or more of said at least one branch.

21. The flexible wiring harness of claim 19 further comprising a connector attached to each end of said wire bundle.

22. The flexible wiring harness of claim 18 further comprising a connector attached at an end of said at least one branch.

23. The flexible wiring harness of claim 18 further comprising a connector attached to an end of each individual wire of said at least one branch.
